(19) United States
(12) Patent Application Publication
(10) Pub. No.: US 2003/0033345 A1
(43) Pub. Date: Feb. 13, 2003

(54) Thread-based methods and systems for using the idle processing power of one or more networked computers to solve complex scientific problems

(76) Inventors: Christopher E. Keefer, Durham, NC (US); Stephane Murphy, Morrisville, NC (US); Joseph D. Simpkins, Cary, NC (US); Sidney Stanley Young, Durham, NC (US)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/148,100

(22) PCT Filed: Nov. 29, 2000
(86) PCT No.: PCT/US00/32535

(51) Int. Cl. G06F 9/00

(52) U.S. Cl. 709/102; 709/203

(57) ABSTRACT

Thread-based methods and systems for using the idle processing power of one or more networked computers include at least one server and at least one client. The server stores data and job descriptions relating to a complex scientific problem and provides the job descriptions and portions of the data to clients in response to requests from the clients. Each of the clients starts a first idle thread for pulling job descriptions from the server. Each client also starts a second idle thread for requesting data from the server and for performing the job specified in the job description. The first and second idle threads are automatically scheduled for execution by the operating system.

### RELATED APPLICATION INFORMATION

This application claims the benefit of U.S. provisional patent application No. 60/167,925, filed Nov. 29, 1999, the disclosure of which is incorporated herein by reference in its entirety.

### TECHNICAL FIELD

The present invention relates to methods and systems for using the idle processing power of one or more networked computers to solve complex scientific problems. More particularly, the present invention relates to thread-based methods and systems for using the idle processing power of one or more networked computers to solve complex scientific problems.

### BACKGROUND ART

Many medium-to-large size enterprises have a large number of desktop computers that are connected via one or more networks. These computers are typically idle a great deal of the time. For example, such machines may be idle on nights, weekends, and while employees are otherwise engaged. A recent sampling indicates that desktop machines are being used less than 5% of the time. Servers are also typically idle over 90% of the time. In light of the unharnessed computing power of idle desktop machines, methods and systems have been developed to utilize this computing power to solve complex problems.

For example, U.S. Pat. No. 6,112,225 to Kraft et al. discloses a task distribution processing system and method for subscribing computers to perform computing tasks during idle time. In the Kraft et al. system, peripheral computers are required to download an idle time activation program from a coordinating computer. The idle time activation program can include a screen saver that determines when the peripheral computer is idle based on processing load or a predetermined time period since the user has accessed the keyboard. Requiring users to download an idle time activation program is undesirable since it must be done for each computer that is desired to participate in the aggregate task. In addition, executing a program that measures processing load or time since keyboard access consumes machine cycles on the peripheral computers, thus wasting idle time that could otherwise be used to perform the aggregate task.

U.S. Pat. No. 5,031,089 to Liu et al. discloses a dynamic resource allocation scheme for distributed heterogeneous computer systems. In Liu et al., a plurality of peer nodes include logic for calculating and saving a workload value that indicates the number of jobs in the node's queue. Each node has logic for transferring work to other peer nodes. Finally, each node has logic that operates at the completion of each job that checks the node's own workload value and polls all of the other peer nodes for their workload values. If the node's own workload is low and the other nodes' workloads are high, the checking node will pull work from another overloaded node. While the system in Liu et al. may achieve load balancing among peer computers, such a system may overburden the network connecting the peer nodes with traffic between peer nodes that are continuously trying to balance their loads. Such traffic could congest the network and would not be transparent to the user. Therefore, the system disclosed in Liu et al. may be undesirable in a network where the computers used to solve the distributed processing problem are also used by end users.

For example, in a large organization, such as a pharmaceutical manufacturing company, end users may utilize their computers for email, web browsing, document authoring, and other tasks. If one or more computers on the network connected to these computers are solving a complex scientific problem in which peer-based load balancing is used, the traffic required to implement peer-based load balancing may overburden the network and interfere with communications to and from computers that are not idle. Accordingly, the system disclosed in Liu et al. may only be suitable for distributed computers dedicated to solve a complex problem.

In light of the difficulties associated with conventional distributed computing algorithms, there exists a long-felt need for methods and systems for using the idle processing power of networked computers to solve complex problems in a way that minimizes the impact on the end user.

### DISCLOSURE OF THE INVENTION

According to one aspect, the present invention includes an thread-based system for solving complex scientific problems. Such a system includes a client that pulls work from a server relating to a complex scientific task. More particularly, the client includes computer code for starting a first thread for pulling a job description from the server and a second thread for pulling data from the server. The client allows the operating system to automatically schedule execution of the first and second threads. The first and second threads are preferably idle threads. As used herein, the phrase “idle threads” refers to threads that are of lower priority than user threads. User threads are those threads which are scheduled by user programs, such as word processing programs, email programs, etc. The word “threads,” as used herein, refers to threads of execution, which are running instances of a program.

The thread-based system according to embodiments of the present invention is preferably used by network computers to solve a complex scientific task. Because the code on the clients is executed automatically when the client operating system schedules an idle thread for execution, the impact on the user is minimized. In addition, as will be discussed in more detail below, such a system preferably works on a complex task that is divided into small parts, such that the data transmitted over the network to perform the task is minimized and the work performed by each client is maximized. Computationally-intensive tasks that may be performed by clients according to the present invention include, for example, determining the three-dimensional characteristics of molecules and determining other physical properties of molecules. In such a system, the clients may pull a molecule or a set of molecules from a collection accessible by the server. The clients may then perform the complex calculations required to determine the properties of the molecules. The clients then report the results of the computations back to the server. Because molecule representations are typically short, the data transmitted over the network is minimized. In addition, because the computations required to determine three-dimensional properties and other characteristics of molecules is computationally-intensive, the clients perform a large amount of work. Accordingly, the goals of minimizing network traffic and maximizing work by clients are achieved.

Accordingly, it is an object of the present invention to provide a method and system for using the idle processing power of one or more networked computers to solve a complex scientific problem that minimizes the impact on the user and the user's network.

Some of the objects of the invention having been stated hereinabove, other objects will be evident as the description proceeds, when taken in connection with the accompanying drawings as best described hereinbelow.

### BRIEF DESCRIPTION OF THE DRAWINGS

Preferred embodiments of the invention will now be explained with reference to the accompanying drawings of which:

FIG. 1 is a block diagram illustrating an exemplary operating environment for embodiments of the present invention;

FIG. 2 is a schematic diagram of a thread-based system for solving complex scientific problems according to an embodiment of the present invention;

FIG. 3 is a flow chart illustrating exemplary steps performed by a client in pulling a job from a server and performing the work required by the job using threads that are automatically scheduled by the operating system according to an embodiment of the present invention; and

FIG. 4 is a block diagram illustrating the automatic scheduling of threads by an operating system, which is used by embodiments of the present invention to solve complex scientific problems.

### DETAILED DESCRIPTION OF THE INVENTION

### Exemplary Operating Environment

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

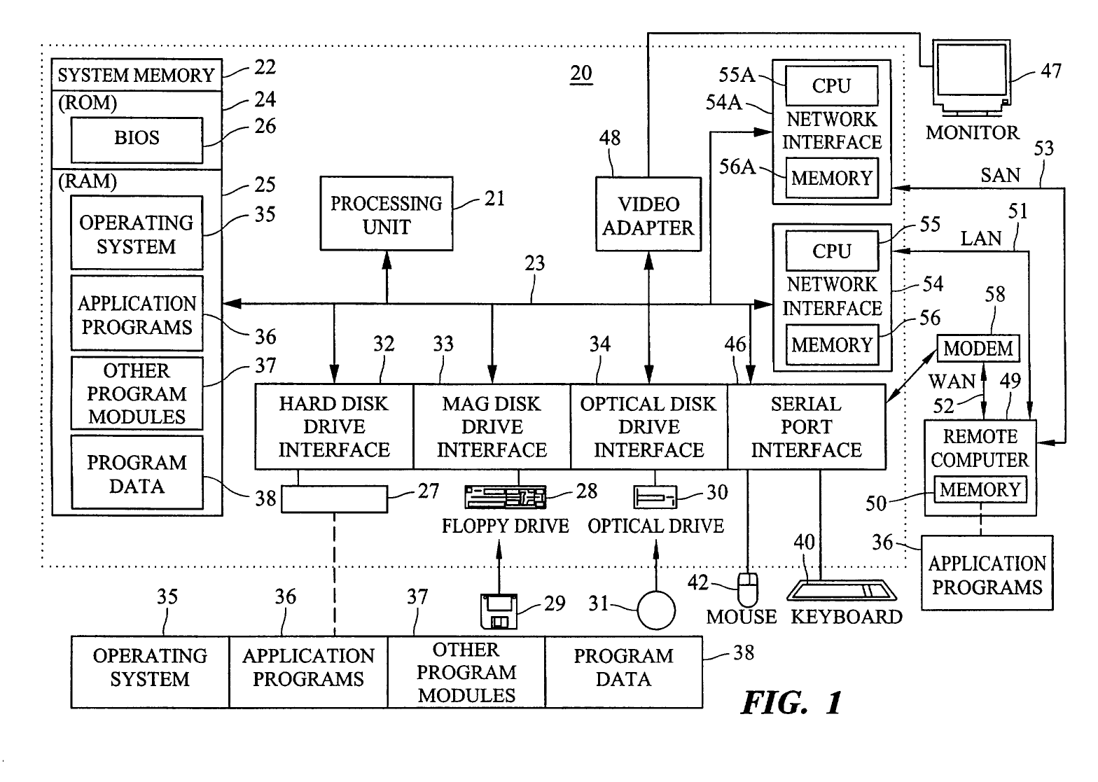

With reference to FIG. 1, an exemplary system for implementing the invention includes a general purpose computing device in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk, magnetic disk 29, optical disk 31, ROM 24 or RAM 25, including an operating system 35, one or more applications programs 36, other program modules 37, and program data 38. The operating system 35 may include a thread scheduler that automatically schedules execution of threads in accordance with thread priority levels set by user programs. A user may enter commands and information into the personal computer 20 through input devices such as a keyboard 40 and a pointing device 42. Other input devices (not shown) may include a microphone, touch panel, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51, a wide area network (WAN) 52, and a system area network (SAN) 53. Local- and wide-area networking environments are commonplace in offices, enterprise-wide computer networks, intranets and the Internet.

System area networking environments are used to interconnect nodes within a distributed computing system, such as a cluster. For example, in the illustrated embodiment, the personal computer 20 may comprise a first node in a cluster and the remote computer 49 may comprise a second node in the cluster. In such an environment, it is preferable that the personal computer 20 and the remote computer 49 be under a common administrative domain. Thus, although the computer 49 is labeled “remote”, the computer 49 may be in close physical proximity to the personal computer 20.

When used in a LAN or SAN networking environment, the personal computer 20 is connected to the local network 51 or system network 53 through the network interface adapters 54 and 54a. The network interface adapters 54 and 54a may include processing units 55 and 55a and one or more memory units 56 and 56a.

When used in a WAN networking environment, the personal computer 20 typically includes a modem 58 or other means for establishing communications over the WAN 52. The modem 58, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

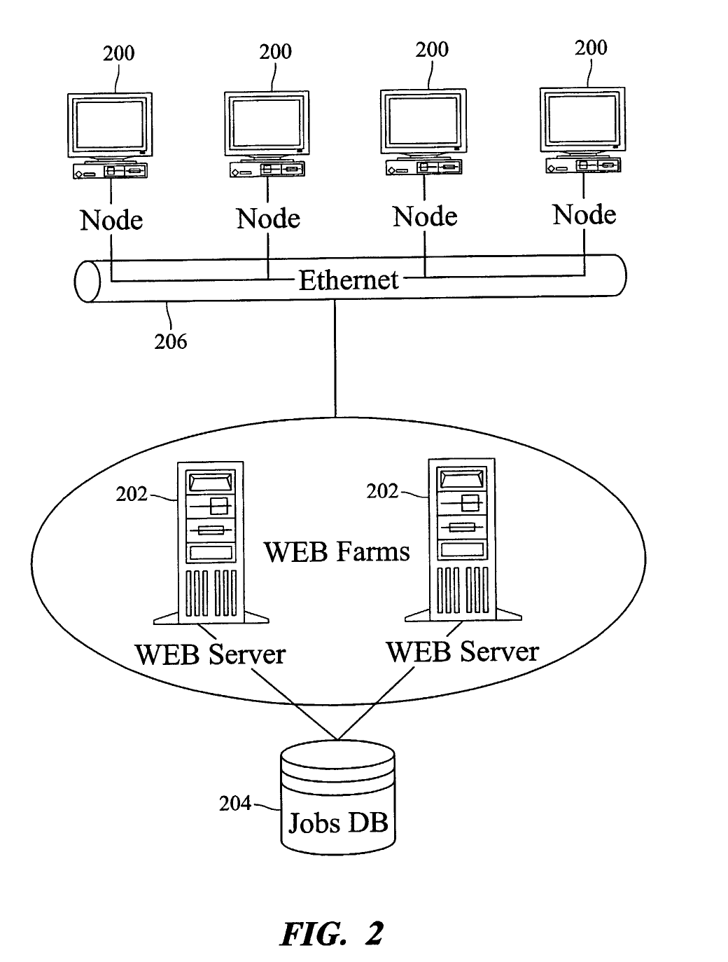

FIG. 2 illustrates an thread-based system for solving complex scientific problems according to an embodiment of the present invention. In FIG. 2, the system includes a plurality of client nodes 200, server nodes 202, and a jobs database 204. Client nodes 200 and server nodes 202 may be similar in configuration to personal computer 20 illustrated in FIG. 1. Jobs database 204 may also include a front-end computer that is similar to personal computer 20 illustrated in FIG. 1. In the illustrated embodiment, client nodes 200 are connected via an Ethernet 206. However, the present invention is not limited to interconnecting client nodes via an Ethernet. Any local area network technology can be used, for example, in an alternative embodiment, token ring or FDDI may be used.

Client nodes 200 each include computer-executable instructions for pulling work from server nodes 202 based on the scheduling of idle threads by the operating systems of client nodes 200. Servers 202 may be conventional web servers that respond to hypertext transfer protocol (HTTP) GET requests from clients 200. Web servers 202 may receive data from clients 200 via HTTP PUT requests.

The present invention is not limited to providing data and jobs to clients using web servers. For example, in an alternative embodiment of the invention, servers 202 may be file transfer protocol (FTP) servers. Because client nodes use protocols, such as FTP or HTTP, that are available though standard libraries, the complexity of the client programs is reduced.

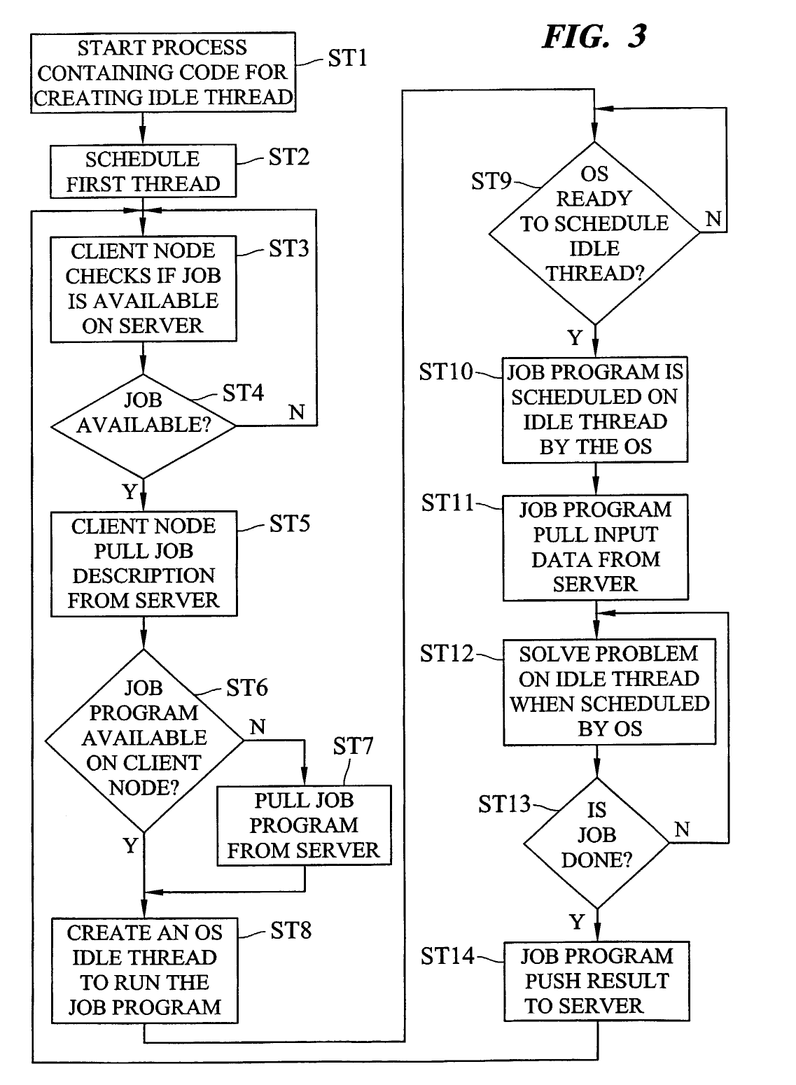

FIG. 3 illustrates exemplary steps for implementing the process of the invention that may be performed by clients 200 in pulling jobs and data from servers 202. Referring to FIG. 3, in step ST1, a process is started containing code for creating a first idle thread. Such a process may be loaded onto a client node when the operating system is loaded on the client node. The process may be started automatically when the operating system starts. Because the code for pulling data from the server is scheduled on an idle thread, this thread will not be executed until all user priority threads are either executed or sleeping. An exemplary mechanism by which an operating system schedules threads will be discussed in more detail below.

In step ST2, the idle thread is scheduled for execution by the operating system. In step ST3, the client node queries the server to determine if any jobs are available. In step ST4, if jobs are not available, the client node continues checking as long as the thread is scheduled for execution. Once a user thread is scheduled or wakes up, the querying automatically ceases.

In step ST4, if the client node receives a response from the server indicating that a job is available, then in step ST5, the client node pulls a job description from the server. As discussed above, pulling a job description from the server may include sending an HTTP GET request to the server. In step ST6, the client node determines whether a job program performing the job specified by the job description is present on the client node. If the required program is not present, in step ST7, the client node pulls the job program from the server.

In step ST8, the client node creates an operating system idle thread to run the job program. This may be accomplished by the following lines of code which may be included in the main( ) function of the program executing on the first thread:

hRunningThread = CreateThread(NULL, 0, &RunningThreadProc,
(void*)this,
CREATE_SUSPENDED, &IThreadID);
SetThreadPriority(hRunningThread, THREAD_PRIORITY_IDLE);
ResumeThread(hRunningThread);

In the code listed above, the commands are C++ commands that are particular to the WINDOWS® operating system. However, it will be apparent to those of ordinary skill in the art that similar commands can be used for other operating systems, such as UNIX-based operating systems. In the illustrated example, the CreateThread( ) function creates a thread to execute within the virtual address space of the calling process. The CreateThread( ) function is past a parameter that specifies the address of the function to be executed by the thread. In this example, this parameter is &RunningThreadProc. The SetThreadPriority sets the priority of the thread to idle. The ResumeThread( ) function decrements a thread suspend count. When the suspend count is decremented to 0, execution of the thread is resumed. The reason that the ResumeThread function is used is the fact that the thread was created in a suspended state in order to allow the priority to be set.

Once the job execution thread has been created, the thread is not executed until it is scheduled by the operating system. This is evinced by step ST9 in FIG. 3. In step ST10, once the operating system schedules the job execution thread, the job program is executed. In step ST11, the job program pulls input data from the server. Such an action may be accomplished by the problem specified by the job description and the input data is solved when the idle thread containing the job program is scheduled by the operating system. Solving of the problem continues until the job is done (step ST13 ) or until another higher-priority thread is scheduled. If a higher-priority thread is scheduled, the operating system saves the context of the idle thread, executes the higher-priority thread, and then returns to execution of the idle thread. In step ST14, once the job is done, the job program pushes the result to the server. This may be accomplished using an HTTP or FTP PUT request.

Although the embodiment illustrated in FIG. 3 shows the scheduling of first and second idle threads by the operating system to perform a complex scientific task, the present invention is not limited to using two idle threads. For example, a single thread or more than two threads may be used. In addition, the threads need not be idle threads. All that is required for purposes of the present invention is that the threads be of lower priority than user threads to minimize the impact on user threads and that the threads be automatically scheduled by the operating system.

Thus, as illustrated in FIG. 3, the present invention utilizes the automatic thread scheduling mechanism of the operating system to control the pulling of job data and programs from the server, the execution of the jobs, and the pushing of the results back to the server. Because the scheduling is accomplished using automatic scheduling procedures of the operating system, the impact on the user and the user's computer is minimized.

### Automatic Scheduling of Thread Execution by the Operating System

Because an important feature of the invention is allowing the operating system to automatically schedule the threads for pulling work from the server, a discussion of such automatic scheduling follows. The discussion that follows illustrates how the WINDOWS® NT operating system automatically schedules threads. However, as discussed above, the present invention is not limited to the WINDOWS® NT operating systems. Other operating systems, such as LINUX® or other UNIX-based operating systems, may be used. Any operating system that includes an automatic thread-scheduling mechanism that allows priorities to be set between threads may be used to implement the present invention.

In the WINDOWS® NT operating system, the microkernel schedules ready threads for processor time based upon their dynamic priority, a number from 1 to 31 which represents the importance of the task. The highest priority thread always runs on the processor, even if this requires that a lower-priority thread be interrupted. Priorities are organized in a hierarchy. Each level of the priority hierarchy establishes a range within which the lower level priorities can vary:

1-

The base priority class of a process establishes a range for the base priority of the process and of its threads. The base priority classes are Idle, Normal, High, and Real-Time, each representing a numeric range of base priorities that sometimes overlap at the extremes. The base priority class is set in the application code. Exemplary application code that may be used to set the base priority class is as follows:

SetPriorityClass(::GetCurrentProcess( ), IDLE_PRIORITY_CLASS);

SetThreadPriority(::GetCurrentThread( ), THREAD_PRIORITY_IDLE);

The operating system does not change the base priority class, but it does vary the base priority within the class to improve the response of processes to the user.

2-

The base priority of a process varies within the range established by its base priority class. When a user interacts with a process (the process window is at the top of the WINDOWS® stack), WINDOWS® NT boosts the base priority of the process to maximize its response. The base priority of a thread is a function of the base priority of the process in which it runs. Except for Idle and Real-Time threads, the base priority of a thread varies only within +/−2 from the base priority of its process.

3-

The dynamic priority of a thread is a function of its base priority. WINDOWS® NT continually adjusts the dynamic priority of threads within the range established by its base priority. This helps to optimize the system's response to users and to balance the needs of system services and other lower priority processes to run, however briefly.

The following table illustrates base priority classes and corresponding thread priorities:

| Base | | |
|---|---|---|
| Priority | | |
| Class | Thread Priority | Description |
| 31 | Real-time | Time critical |
| 26 | Real-time | Highest |
| 25 | Real-time | Above normal |
| 24 | Real-time | Normal |
| 23 | Real-time | Below normal |
| 22 | Real-time | Lowest |
| 16 | Real-time | Idle |
| 15 | Idle, Normal, or High | Time critical |
| 15 | High | Highest |
| 14 | High | Above normal |
| 13 | High | Normal |
| 12 | High | Below normal |
| 11 | High | Lowest |
| 10 | Normal | Highest |
| 9 | Normal | Above normal |
| 8 | Normal | Normal |
| 7 | Normal | Below normal |
| 6 | Normal | Lowest |
| 6 | Idle | Highest |
| 5 | Idle | Above Normal |
| 4 | Idle | Normal |
| 3 | Idle | Below normal |
| 2 | Idle | Lowest |
| 1 | Idle, Normal, or High | Idle |

### Context Switches

As discussed above, the scheduler maintains a queue of executable threads for each priority level. When a processor becomes available, the system performs a context switch. The steps in a context switch are:

Save the context of the thread that just finished executing.

Place the thread that just finished executing at the end of the queue for its priority.

Find the highest priority queue that contains ready threads.

Remove the thread at the head of the queue, load its context, and execute it.

The most common reasons for a context switch are:

The time slice has elapsed.

A thread with a higher priority has become ready to run.

A running thread needs to wait.

When a running thread needs to wait, it relinquishes the remainder of its time slice.

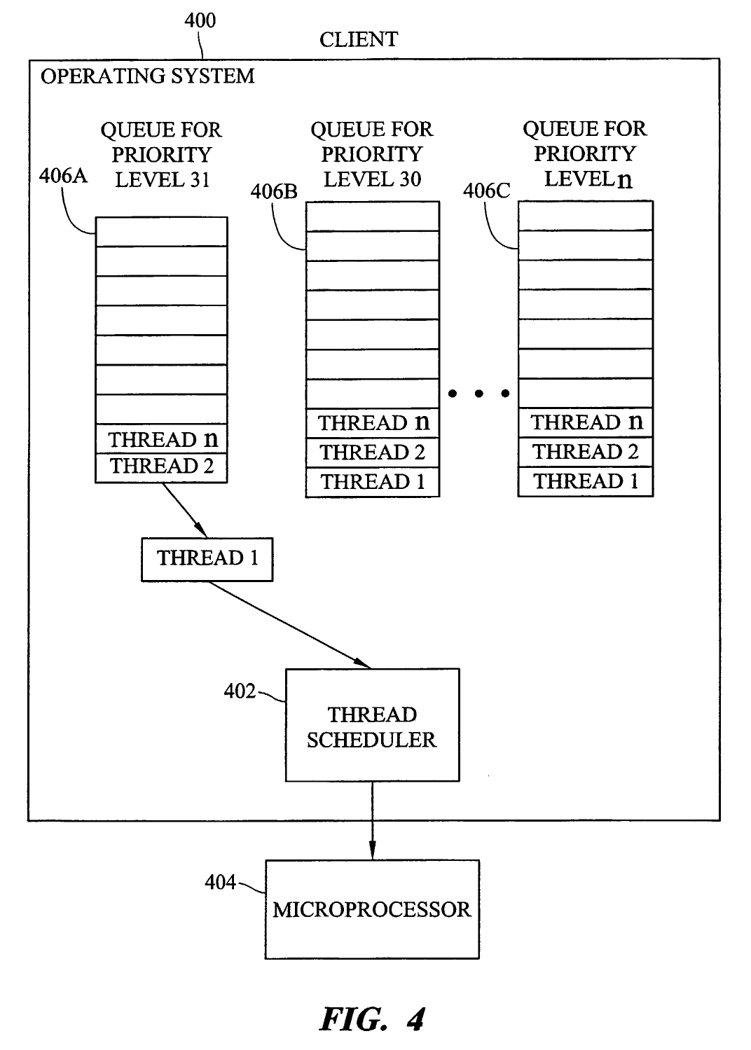

FIG. 4 is a block diagram illustrating the thread scheduling that occurs on a client according to an embodiment of the present invention. In FIG. 4, operating system 400 includes a thread scheduler 402 that schedules threads for execution on one or more microprocessors 404. Thread scheduler 402 maintains a plurality of queues 406a-406n. In the illustrated example, queue 406a contains ready threads for priority level 31, which is the highest priority level in the WINDOWS® NT operating system. Queue 406b contains threads for priority level 30, which is the next-to-highest priority level. Finally, queue 406n contains threads for a lower priority level, such as idle threads. It is in queue 406n where the programs for pulling job data from the server and executing job programs will reside.

As discussed above, thread scheduler 402 schedules threads from the higher priority queues before scheduling threads from the lower priority queues. In the illustrated example, thread scheduler 402 pulls thread 1 from the head of queue 406a since this is the thread at the head of the highest priority queue. All of the threads in queues 406a and 406b will be executed before the threads in queue 406n. Since user processes are scheduled on the higher priority threads, the programs for pulling job data from the server and executing the jobs will have minimal impact on the user.

### Scientific Applications

As discussed above, the thread-based methods and systems of the present invention for utilizing the idle processing power of one or more networked computers may be used to solve complex scientific problems. In solving such problems, the data sent over the network is preferably minimized and the computation performed by the clients is preferably maximized. One representative example of a scientific problem that embodiments of the present invention may be used to solve is determining three-dimensional conformations of molecules. For example, large pharmaceutical companies may have collections containing many thousands of molecules. For one computer to determine the three-dimensional properties of all of these molecules would tie up the computer for a year or more. Accordingly, it is desirable to divide this task among client computers. Referring back to FIG. 2, a collection of molecules may be stored in jobs database 204. Each molecule may be represented by a character string. Client nodes 200 may pull a single molecule or a subset of molecules from jobs database 204 via web servers 202. Once the nodes 200 receive the molecule representations, the nodes 200 perform complex calculations for each molecule. The results are then sent back to web servers 202. Because the processing of the collection of molecules can be distributed across multiple nodes using the idle processing capacity of those nodes, the time and expense required to perform such processing is reduced.

Another representative application for the thread-based methods and systems of the present invention includes computing properties of molecules in a collection of molecules. In such an example, client nodes 200 pull molecule descriptions from jobs database 204. Client nodes 200 then execute programs for computing properties, such as molecular weight, distance between atoms, surface area or whether the molecule is capable of docking with a particular protein.

It will be understood that various details of the invention may be changed without departing from the scope of the invention. Furthermore, the foregoing description is for the purpose of illustration only, and not for the purpose of limitation—the invention being defined by the claims.

What is claimed is:

1. A thread-based method for using the idle processing power of one or more networked computers to solve a complex problem, the method comprising:
(a) starting a thread on a client computer for pulling a job description relating to a sub-part of a complex problem from a server;
(b) allowing a thread-scheduler provided by an operating system executing on the client computer to automatically schedule execution of the thread; and
(c) in response to receiving data from the server, pulling job data from the server and solving the sub-part specified by the job description.

2. The method of claim 1 wherein pulling a job description relating to a sub-part of a complex problem from a server includes sending a hypertext transfer protocol (HTTP) GET request to a web server.

3. The method of claim 1 wherein pulling a job description relating to a sub-part of a complex problem from a server includes sending a file transfer protocol (FTP) GET request to an FTP server.

4. The method of claim 1 wherein starting the thread includes assigning a priority to the thread that is lower than a priority of any user thread.

5. The method of claim 4 wherein the thread scheduler schedules execution of the thread based on the priority assigned to the thread.

6. The method of claim 1 wherein the thread determines whether a job program specified in the job description is resident on the client computer and in response to determining that the job program is not resident on the client computer, the thread pulls the job program from the server computer.

7. The method of claim 6 wherein pulling the job program from the server computer includes sending a hypertext transfer protocol (HTTP) GET request to a web server.

8. The method of claim 6 wherein pulling the job program from the server includes sending a file transfer protocol (FTP) GET request to an FTP server.

9. The method of claim 1 wherein the complex problem includes computing properties of molecules in a collection and wherein pulling data from the server includes pulling a representation of a single molecule or representations of a subset of molecules from the collection.

10. The method of claim 9 wherein computing properties of molecules in the collection includes determining whether the molecules will dock with a predetermined protein.

11. The method of claim 9 wherein computing properties of molecules in the collection includes determining three-dimensional conformations of each molecule in the collection of molecules.

12. A thread-based system for utilizing the idle processing power of one or more computers connected via a network to solve a complex problem, the system comprising:
(a) a server including computer-executable instructions for storing data and job descriptions relating to a complex problem and for providing the data and the job descriptions to clients in response to requests from the clients; and
(b) a client including computer-executable instructions for starting a thread for pulling a job description from the server, for pulling data from the server, and for allowing an operating system to automatically schedule execution of the thread.

13. The system of claim 12 wherein the server comprises a hypertext transfer protocol (HTTP) server.

14. The system of claim 12 wherein the server comprises a file transfer protocol (FTP) server.

15. The system of claim 12 wherein the thread comprises an idle thread.

16. The system of claim 12 wherein the complex problem includes computing properties of molecules in a collection of molecules and the client is adapted to pull a representation of a single molecule or a subset of molecules from the collection at the server.

17. The system of claim 16 wherein computing properties of molecules in a collection of molecules includes determining three-dimensional conformations of each molecule in the collection of molecules.

18. The system of claim 16 wherein computing properties of molecules in a collection of molecules includes determining whether the molecules in the collection will dock with a predetermined protein.

19. A computer program product comprising computer-executable instructions embodied in a computer-readable medium for performing steps comprising:
(a) starting a thread on a client computer for pulling a job description relating to a sub-part of a complex problem from a server;
(b) allowing a thread-scheduler provided by an operating system executing on the client computer to automatically schedule execution of the thread; and
(c) in response to receiving data from the server, pulling job data from the server solving the sub-part specified by the job description.

20. The computer program product of claim 19 wherein pulling a job description relating to a sub-part of a complex problem from a server includes sending a hypertext transfer protocol (HTTP) GET request to a web server.

21. The computer program product of claim 19 wherein pulling a job description relating to a sub-part of a complex problem from a server includes sending a file transfer protocol (FTP) GET request to an FTP server.

22. The computer program product of claim 19 wherein starting the thread includes assigning a priority to the thread that is lower than a priority of any user thread.

23. The computer program product of claim 22 wherein the thread scheduler schedules execution of the thread based on the priority assigned to the thread.

24. The computer program product of claim 19 wherein the thread determines whether a job program specified in the job description is resident on the client computer and in response to determining that the job program is not resident on the client computer, the thread pulls the job program from the server computer.

25. The computer program product of claim 24 wherein pulling the job program from the server computer includes sending a hypertext transfer protocol (HTTP) GET request to a web server.

26. The computer program product of claim 24 wherein pulling the job program from the server includes sending a file transfer protocol (FTP) GET request to an FTP server.

27. The computer program product of claim 19 wherein the complex scientific problem includes computing properties of molecules in a collection and wherein pulling data from the server includes pulling a representation of a single molecule or representations of a subset of molecules from the collection.

28. The computer program product of claim 27 wherein computing properties of molecules in a collection includes determining three-dimensional conformations of each molecule in the collection.

29. The computer program product of claim 27 wherein computing properties of molecules in a collection includes determining whether the molecules will dock with a predetermined protein.
